(19) United States
(12) Patent Application Publication
(10) Pub. No.: US 2015/0058529 A1
(43) Pub. Date: Feb. 26, 2015

(54) SYSTEMS AND METHODS OF PROCESSING ACCESS REQUESTS AT A DATA STORAGE DEVICE

(71) Applicant: SANDISK TECHNOLOGIES INC., PLANO, TX (US)

(72) Inventors: GARY LIN, SAN JOSE, CA (US); SERGEY ANATOLIEVICH GOROBETS, EDINBURGH (GB); DANIEL EDWARD TUERS, KAPAA, HI (US); ROBERT JACKSON, MILPITAS, CA (US)

(73) Assignee: SANDISK TECHNOLOGIES INC., PLANO, TX (US)

(21) Appl. No.: 13/972,296

(22) Filed: Aug. 21, 2013

(51) Int. Cl. G06F 3/06

(52) U.S. Cl. CPC G06F 3/0659; G06F 3/0604; G06F 3/0679
USPC 711/103; 711/154

(57) ABSTRACT

A data storage device includes a non-volatile memory and a controller. A method performed in the data storage device includes sending multiple access requests to a plurality of non-volatile memory devices of the data storage device. The multiple access requests correspond to a command and are associated with a first order. The method further includes receiving a plurality of output data items from the plurality of non-volatile memory devices. The plurality of output data items is based on the multiple access requests and is received in a second order that is different from the first order. The method also includes reordering the plurality of output data items according to the first order.

### FIELD OF THE DISCLOSURE

The present disclosure is generally related to processing of access requests at a data storage device.

### BACKGROUND

Non-volatile data storage devices, such as embedded memory devices (e.g., embedded MultiMedia Card (eMMC) devices) and removable memory devices (e.g., removable universal serial bus (USB) flash memory devices and other removable storage cards), have allowed for increased portability of data and software applications. Users of non-volatile data storage devices increasingly rely on the non-volatile storage devices to store and provide rapid access to a large amount of data. For example, a user may store large audio files, images, videos, and other files at a data storage device.

A non-volatile data storage device may include a single engine to process commands (e.g., access requests) received from a host device in an order (e.g., a sequential order) that the commands are received. The commands may include a series of commands or a long command including a plurality of sub-commands (e.g., multiple data requests). The single engine may execute the commands sequentially, in a serial manner (e.g., one by one), and may output data corresponding to each of the commands in the order processed. Because of the serial manner in which the commands are processed, processing a lengthy set of commands may be a time consuming process.

### SUMMARY

A data storage device includes a controller and a memory, such as a non-volatile memory. The controller may be configured to receive one or more commands, such as a series of commands or a long command having multiple sub-commands, associated with a first order (e.g., a sequential order) and to concurrently (e.g., in parallel) execute the one or more commands. Each command of the one or more commands or each subcommand of the multiple subcommands may correspond to an access request to be executed at the memory. The controller may be configured to receive a plurality of output data items based on the executed one or more commands (or the multiple subcommands) in a second order and provide the output data items according to the first order as output data of the data storage device.

The controller may enable parallel execution of the commands (or sub-commands) by generating one or more tags that are attached to the commands (or sub-commands). The one or more tags may enable the controller to order, or reorder, output data according to the first order. For example, the controller may receive a plurality of output data items from multiple memory devices responsive to the parallel execution of the commands (or sub-commands). An output data item from each memory device may correspond to a particular command (or a particular sub-command) and may be associated with a particular tag assigned to the particular command (or the particular sub-command). The plurality of output data items may be received from the multiple memory devices in a second order that is different than the first order. The controller may reorder the plurality of output data items according to the first order based on the one or more tags. The reordered output data may be output by the controller. For example, the controller may provide the plurality of output data items (reordered in the first order) to a host device that sent the one or more commands to the controller. By assigning one or more tags to the one or more commands based on the first order, the controller may execute the one or more commands in any order (e.g., in parallel) and provide output data according to the first order based on the one or more commands.

In a particular embodiment, a method performed at a controller of a data storage device includes sending multiple access requests to a plurality of non-volatile memory devices of a data storage device. The multiple access requests are associated with a first order and are associated with at least one command. The method also includes receiving a plurality of output data items from the plurality of non-volatile memory devices. The plurality of output data items is based on the multiple access requests and is received in a second order that is different from the first order. The method further includes reordering the plurality of output data items according to the first order.

In another particular embodiment, a data storage device includes a command sequencer configured to generate multiple groups. The multiple groups are associated with a first order and are associated with at least one command received by the command sequencer. The data storage device also includes a plurality of direct memory access modules configured to receive a plurality of output data items from a plurality of non-volatile memory devices. The plurality of output data items is based on the multiple groups and is received in a second order that is different than the first order. The data storage device further includes a data sequencer configured to reorder the plurality of output data items according to the first order.

### BRIEF DESCRIPTION OF THE DRAWINGS

FIG. 1 is a block diagram of a particular illustrative embodiment of a system including a data storage device that includes a command sequencer and a data sequencer;

FIG. 2 is block diagram of a first illustrative embodiment of the data storage device of FIG. 1;

FIG. 3 is block diagram of a second illustrative embodiment of the data storage device of FIG. 1; and

FIG. 4 is a flow diagram of an illustrative method of operating a data storage device.

### DETAILED DESCRIPTION

Particular embodiments of the present disclosure are described below with reference to the drawings. In the description, common features are designated by common reference numbers throughout the drawings.

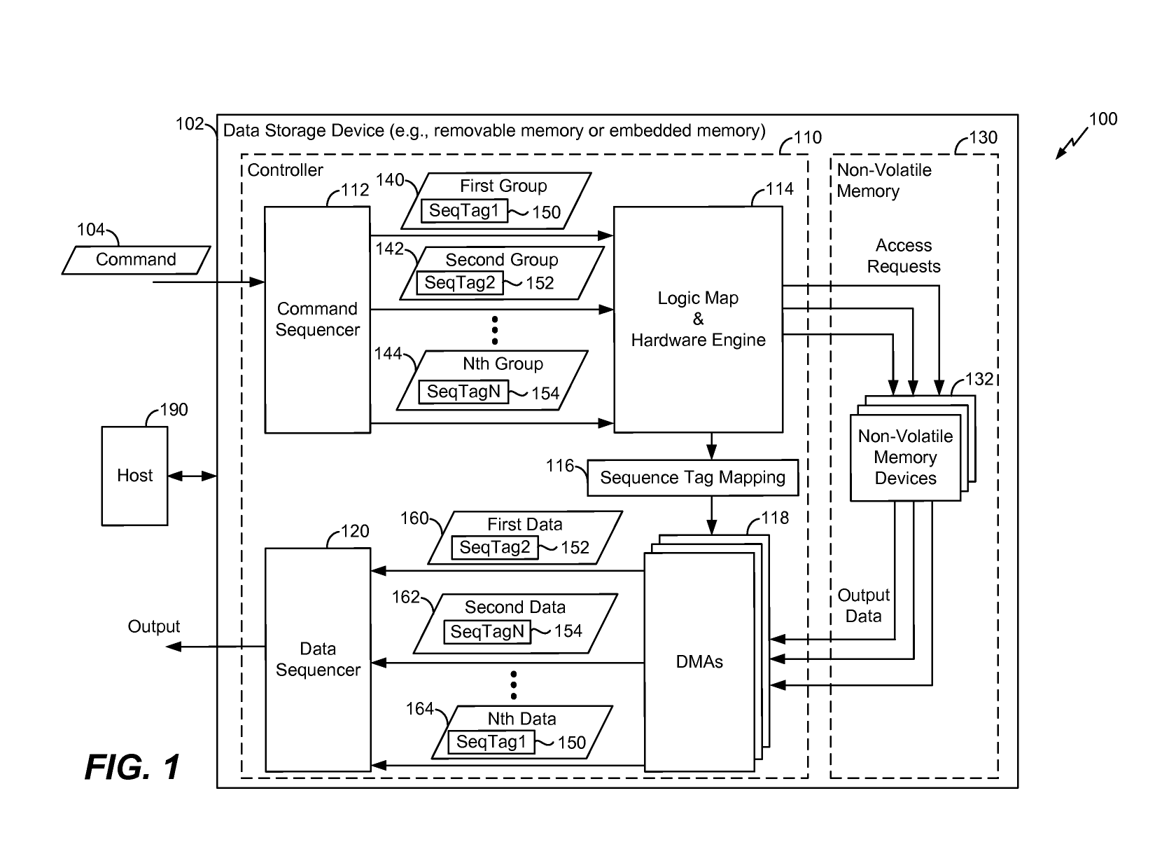

FIG. 1 depicts a particular embodiment of a system 100 that includes a host device 190 and a data storage module, such as a data storage device 102. The particular example of FIG. 1 depicts that the data storage device 102 is external to (e.g., is removable from) the host device 190. For example, the data storage device 102 may be a removable memory that performs certain operations and methods described herein when operatively coupled (e.g., via an interface) to the host device 190. According to other embodiments, the data storage device 102 corresponds to an embedded memory that is included within (e.g., embedded within) the host device 190.

The data storage device 102 may be a memory card, such as a Secure Digital SD® card, a microSD® card, a miniSD™ card (trademarks of SD-3C LLC, Wilmington, Del.), a MultiMediaCard™ (MMC™) card (trademark of a Joint Electron Devices Engineering Council (JEDEC) Solid State Technology Association, Arlington, Va.), or a CompactFlash® (CF) card (trademark of SanDisk Corporation, Milpitas, Calif.). Alternatively, the data storage device 102 may be embedded memory in the host device 190, such as eMMC® (trademark of JEDEC Solid State Technology Association, Arlington, Va.) memory and eSD memory, as illustrative examples. To illustrate, the data storage device 102 may correspond to an embedded MultiMedia Card (eMMC) device. The data storage device 102 may operate in compliance with a Joint Electron Devices Engineering Council (JEDEC) industry specification. For example, the data storage device 102 may operate in compliance with a JEDEC eMMC specification, a JEDEC Universal Flash Storage (UFS) specification, one or more other specifications, or a combination thereof.

The data storage device 102 includes a controller 110 and a non-volatile memory 130. The controller 110 may be coupled to a memory array, such as the non-volatile memory devices 132, of the non-volatile memory 130. The controller 110 may include a command sequencer 112, a logic map and hardware engine 114, a sequence tag mapping data structure 116, multiple direct memory access (DMA) modules 118, and a data sequencer 120.

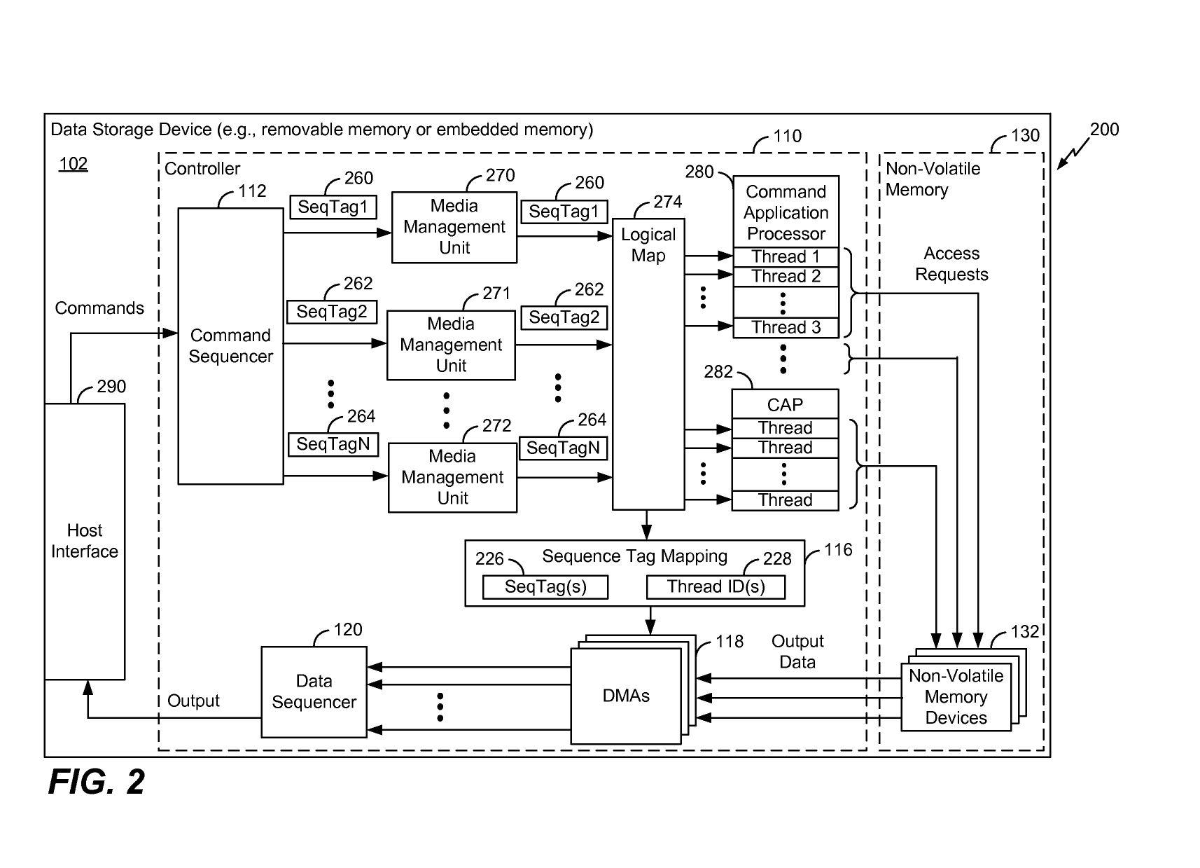

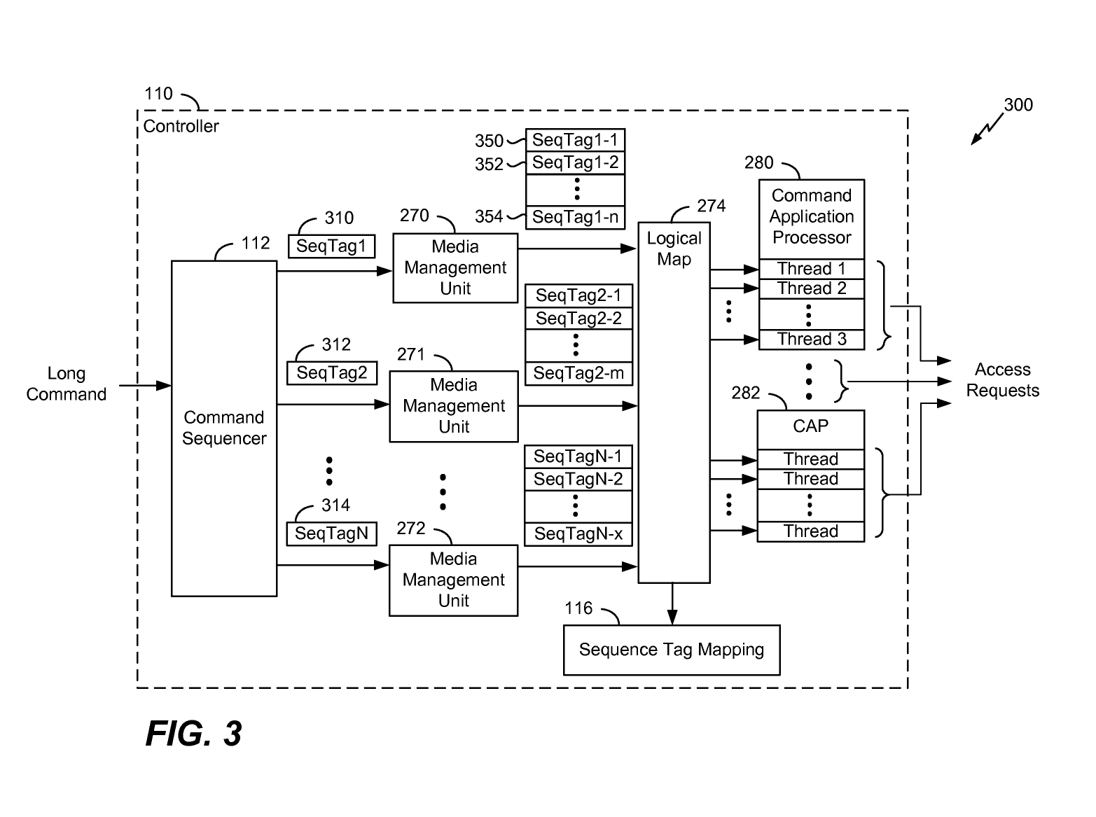

The command sequencer 112 may be configured to receive a command 104 that includes a request to access the non-volatile memory 130. The command 104 may be a long command having a plurality of sub-commands. In a particular embodiment, the command 104 is received from the host device 190. The command sequencer 112 may be configured to divide the command 104 into multiple groups, such as a first group 140, a second group 142, and an Nth group 144. Although three groups 140-144 are shown in the system 100, the system 100 may include fewer than three groups or more than three groups. Each of the multiple groups 140-144 may include a single command of a series of commands or one or more sub-commands based on the command 104. For example, the command 104 may include multiple commands and each command may correspond to a different group of the multiple groups 140-144, as described with reference to FIG. 2. As another example, each of the multiple groups 140-144 may include one or more sub-commands of a long command, as described with reference to FIG. 3. As depicted in FIG. 1, each of the multiple groups 140-144 may be considered to include a single command of a series of commands or, alternatively, a single sub-command of a long command.

The multiple groups 140-144 may be associated with a first order, such as a sequential order, based on the command 104. For example, when the command 104 is the long command, the first order may be based on an order (e.g., a sequential order) of the plurality of sub-commands included in the long command. As another example, when the command 104 is the series of commands, the first order may be based on an order (e.g., a sequential order) that the series of commands are received by the command sequencer 112.

The command sequencer 112 may generate one or more tags (e.g., one or more sequence tags) based on the first order. For example, the command sequencer 112 may generate multiple tags, such as a first tag 150, a second tag 152, and an Nth tag 154. The command sequencer 112 may attach a corresponding tag of the multiple tags 150-154 to each of the multiple groups 140-144 based on the first order. For example, the command sequencer 112 may attach the first tag 150 to the first group 140, the second tag 152 to the second group 142, and the Nth tag 154 to the Nth group 144. The command sequencer 112 may provide (e.g., send) the multiple groups 140-144, each having a corresponding attached tag of the multiple tags 150-154, to the logic map and hardware engine 114.

The logic map and hardware engine 114 may receive the multiple groups 140-144 and process the multiple groups 140-144 to generate multiple access requests (e.g., multiple non-volatile memory device commands, such as multiple NAND flash commands), as described herein. The logic map and hardware engine 114 may process the multiple groups 140-144 into the multiple access requests by translating logical addresses associated with the multiple groups 140-144 into physical addresses. The logic map and hardware engine 114 may translate a logical address to a physical address using a logical-to-physical address table. In a particular embodiment, the logic map and hardware engine 114 is configured to process one or more of the multiple groups 140-144 in parallel (e.g., concurrently).

The multiple access requests (e.g., the multiple groups 140-144) may be based on and correspond to the command 104 and may be associated with the first order. Each access request may be associated with a particular tag corresponding to the particular group 140-144 from which the access request is generated. The multiple access requests may include a read access, a write access, or a combination thereof.

Processing of the multiple groups 140-144 may occur concurrently (e.g., at least partially at the same time). For example, the logic map and hardware engine 114 may include multiple processing paths (e.g., multiple processing pipelines) to process the multiple groups 140-144. An amount of time for the logic map and hardware engine 114 to process each group may vary based on one or more processing variations associated with the logic map and hardware engine 114. Alternatively or additionally, a particular amount of time for a particular group to be processed by the logic map and hardware engine 114 may vary depending on a workload of the processing path assigned to process the particular group or depending on the type of access (e.g., a read access or a write access) being requested. For example, the logic map and hardware engine 114 may process the first group 140 in a first amount of time that is different than a second amount of time to process the second group 142. Accordingly, when the logic map and hardware engine 114 receives the first group 140 prior to the second group 142 and processes the first group 140 and the second group 142 in parallel, the logic map and hardware engine 114 may generate and issue a first access request that corresponds to the first group 140 subsequent to generating and issuing a second access request that corresponds to the second group 142.

The logic map and hardware engine 114 may send the multiple access requests to the non-volatile memory 130 based on the physical addresses. For example, the multiple access requests may be sent to a plurality of non-volatile memory devices 132 of the data storage device 102. The logic map and hardware engine 114 may provide each access request to a corresponding non-volatile memory device of a plurality of non-volatile memory devices 132 included in the non-volatile memory 130. For example, the logic map and hardware engine 114 may issue each access request to a corresponding non-volatile memory device based on a physical address that corresponds to the access request. The multiple access requests may be provided to the non-volatile memory devices 132 in any order and one or more of the multiple access requests may be provided in parallel (e.g., concurrently).

As an illustrative example of the operation of the logic map and hardware engine 114, the logic map and hardware engine 114 may translate a first logical address associated with the first group 140 into a first physical address. The first physical address may be associated with a first access request and the first access request may correspond to the first tag 150 attached to the first group 140. The logic map and hardware engine 114 may provide the first access request associated with the first physical address to a first non-volatile memory device of the plurality of non-volatile memory devices 132. The logic map and hardware engine 114 may also translate a second logical address associated with the second group 142 into a second physical address. The second physical address may be associated with a second access request and the second access request may be associated with the second tag 152 attached to the second group 142. The logic map and hardware engine 114 may provide a second access request associated with the second physical address to a second non-volatile memory device the plurality of non-volatile memory devices 132. The logic map and hardware engine 114 may also translate an Nth logical address associated with the Nth group 144 into an Nth physical address. The Nth physical address may be associated with an Nth access request and the Nth access request may be associated with the Nth tag 154 attached to the Nth group 144. The logic map and hardware engine 114 may provide the Nth access request associated with the Nth physical address to an Nth non-volatile memory device of the plurality of non-volatile memory devices 132.

The logic map and hardware engine 114 may populate the sequence tag mapping data structure 116 for each access request provided from the logic map and hardware engine 114 to the non-volatile memory 130. For a particular access request, the logic map and hardware engine 114 may be configured to identify a particular sequence tag assigned to a particular group from which the particular access request is generated. The logic map and hardware engine 116 may be configured to remove the tags 150-154 attached to the groups 140-144 prior to, during, or subsequent to generating the access requests. The logic map and hardware engine 114 may also be configured to determine an identifier associated with a particular non-volatile memory device to receive and execute the particular access request. The logic map and hardware engine 114 may store the particular sequence tag and the identifier at the sequence tag mapping data structure 116. The sequence tag mapping data structure 116 may include one or more memories or registers to enable the controller 110 to track, for a particular access request, a particular tag associated with the particular access request and a particular non-volatile memory device (or thread) to which the particular access request is issued. When the sequence tag mapping data structure 116 comprises a memory, the memory may include a table. The particular non-volatile memory device (or thread) may be tracked using an identifier corresponding to the particular non-volatile memory device (or thread) or by storing the particular tag at a memory location (e.g., a predetermined location) or register of the sequence tag mapping data structure 116 that corresponds to the particular non-volatile memory device. In a particular embodiment, a corresponding tag is stored for each access request of the multiple access requests. The sequence tag mapping data structure 116 may include any data structure, such as a data table, configured to store data. The sequence tag mapping data structure 116 may be accessible to a plurality of direct memory access modules, as described further herein.

The non-volatile memory 130 receives the multiple access requests from the logic map and hardware engine 114. The non-volatile memory 130 may include a memory array, such as the non-volatile memory devices 132. In a particular embodiment, the non-volatile memory 130 may also include or store a logical-to-physical address table, free physical space (e.g., unused physical memory blocks), a file system table, or a combination thereof. In a particular embodiment, the non-volatile memory 130 stores the logical-to-physical address table that is accessible to the controller 110 (e.g., the logic map and hardware engine 114). For example, the logical-to-physical address table may be provided to a random access memory (RAM) included in the controller 110 to enable the logic map and hardware engine 114 to translate logical addresses to physical addresses.

The non-volatile memory devices 132 may include one or more types of storage media such as a flash memory, a one-time programmable memory, other memory, or any combination thereof. In a particular embodiment, the non-volatile memory 130 includes a flash memory (e.g., NAND, NOR, Multi-Level Cell (MLC), Divided bit-line NOR (DINOR), AND, high capacitive coupling ratio (HiCR), asymmetrical contactless transistor (ACT), or other flash memories), an erasable programmable read-only memory (EPROM), an electrically-erasable programmable read-only memory (EEPROM), a read-only memory (ROM), a one-time programmable memory (OTP), or any other type of memory. In a particular embodiment, the plurality of non-volatile memory devices 132 includes a plurality of NAND flash devices.

The non-volatile memory devices 132 may execute (e.g., process) the multiple access requests and generate a plurality of output data items. Execution of the multiple access requests may occur concurrently (e.g., at least partially at the same time or during a common clock cycle). The non-volatile memory devices 132 may provide the output data items to the DMA modules 118 of the controller 110.

The DMA modules 118 may receive the plurality of output data items from the non-volatile memory devices 132 in a second order that is different than the first order. The plurality of output data items may be provided to the DMA modules 118 in response to the access requests that are based on the multiple groups 140-144. The DMA modules 118 may receive the plurality of output data items serially, in parallel, or a combination thereof, and in any order. When the DMA modules 118 receive the plurality of output data items, the DMA modules 118 may be unaware of which group of the multiple groups 140-144 was used to generate each output data item of the plurality of output data items.

The DMA modules 118 may access the sequence tag mapping data structure 116 based on the received plurality of output data items. For example, a particular DMA module 118 may receive a particular output data item and determine an identifier of a particular non-volatile memory device 132 that generated the corresponding particular output data item. For example, the identifier may be included in the received particular output data item. The particular DMA 118 may access the sequence tag mapping data structure 116 using the identifier. For example, the sequence tag mapping data structure 116 may be searchable by the DMA modules 118 to identify one or more sequence tags stored at the sequence tag mapping data structure 116. As another example, each DMA may correspond to a particular non-volatile memory device and may be configured to access a particular memory location or a particular register of the sequence tag mapping data structure 116 in response to receiving the particular output data item. The particular DMA module 118 may identify a particular tag based on the identifier and may attach the particular tag received from the sequence tag mapping data structure 116 to the particular output data item. The particular DMA module 118 may provide the particular output data including the particular tag to the data sequencer 120 as the data 160-164. Accordingly, for the particular output data item of the plurality of output data items, a particular DMA module 118 may determine which group of the multiple groups 140-144 was used to generate an access request from which the particular output data item is based. Once the particular DMA module 118 determines which of the multiple groups 140-144 the particular output data is associated with, the particular DMA module 118 may attach a corresponding tag and send the particular output data item to the data sequencer 120 as one of the data 160-164.

As an illustrative example of the operation of the DMA modules 118, a first DMA module may receive a first data item (e.g., first data 160) and attach the second tag 152 to the first data item, a second DMA module may receive a second data item (e.g., second data 162) and attach the Nth tag 154 to the second data item, and a third DMA module may receive an Nth data item (e.g., Nth data 164) and attach the first tag 150 to the Nth data item. Accordingly, the first data 160 may have been generated in response to the second access request generated based on the second group 142, the second data 162 may have been generated in response to the Nth access request generated based on the Nth group 144, and the Nth data 164 may have been generated in response to the first access request based on the first group 140. The DMA modules 118 may provide the first data 160, the second data 162, and the Nth data 164 to the data sequencer 120. The first data 160, the second data 162, and the Nth data 164 may be provided to the data sequencer 120 in the first order, in the second order, or in any other order.

The data sequencer 120 may be configured to receive the data 160-164 including the tags 150-154 and order the data 160-164 according to the first order based on the tags 150-154 attached to the data 160-164. For example, the data sequencer 120 may order the Nth data 164 in a first sequential position, the first data 160 is a second sequential position, and the second data 162 in a third sequential position.

The data sequencer 120 may be configured to remove the tags 150-154 attached to the data 160-164 during or subsequent to ordering the data 160-164 according to the first order. The data sequencer 120 may provide the data 160-164, according to the first order, as an output of the data storage device 102. For example, the data sequencer 120 may provide the data 160-164 in the first order to the host device 190.

The host device 190 may be communicatively coupled to the data storage device 102. The host device 190 may issue the one or more commands 104 to the data storage device 102 and receive the data 160-164 according to the first order from the data storage device 102. The host device 190 may be communicatively coupled to the data storage device 102 via a host interface (not shown), as described with reference to FIG. 2. The host device 190 may include a mobile telephone, a music player, a video player, a gaming console, an electronic book reader, a personal digital assistant (PDA), a computer, such as a laptop computer, notebook computer, or tablet, any other electronic device, or any combination thereof.

During operation of the data storage device 102, the controller 110 may receive the command 104 from the host device 190 via a host interface. The command 104 may include a single command, such as a long command, or may be included in a series of commands. The command sequencer 112 may divide the command 104 into two or more groups, such as the multiple groups 140-144, and may attach a tag (e.g., a sequence tag) to each of the multiple groups 140-140 based on a first order associated with the multiple groups 140-144.

The multiple groups 140-144, each including a corresponding tag 150-154, may be provided to the logic map and hardware engine 114. The logic map and hardware engine 114 may map each of the multiple groups 140-144 from a corresponding logical address to a corresponding physical address. The logic map and hardware engine 114 may provide (e.g., issue) a plurality of access requests based on the multiple groups 140-144 to the plurality of non-volatile memory devices 132. For each access request that the logic map and hardware engine 114 issues, a tag associated with the access request may be stored in the sequence tag mapping data structure 116.

The non-volatile memory device 132 may execute (e.g., process) the access requests received from the logic map and hardware engine 114 and provide a plurality of output data items (based on the access requests) to the DMA modules 118 in a second order that is different from the first order. The DMA modules 118 may use the sequence tag mapping data structure 116 to identify and attach a corresponding tag for each of the plurality of output data items, such as the data 160-164, based on the plurality of non-volatile memory devices 132. The DMA modules 118 may provide the plurality of data 160-164 including the tags 150-154 to the data sequencer 120.

The data sequencer 120 may receive the plurality of data 160-164 in a second order that is different from the first order. The data sequencer 120 may receive the plurality of data 160-164 in the same order or a different order than the DMA modules 118 received the 160-164. The data sequencer 120 may reorder the plurality of data 160-164 according to the first order based on the tags 150-154 assigned to the plurality of data 160-164 and may send the reordered plurality of data 160-164 to the host device 190.

In a particular embodiment, the controller 110 is programmed (e.g., configured) to receive universal serial bus (USB) protocol instructions and data from a USB interface of a device (e.g., an external host device), such as the host device 190. The controller 110 may include a hardware processor (not shown) that executes instructions stored at an internal memory, such as a read-only memory, to enable receipt and acknowledgment of USB instructions and data.

In another particular embodiment, the controller 110 is programmed (e.g., configured) to receive embedded MultiMedia Card (eMMC) protocol instructions and data from an eMMC interface of a device (e.g., an embedded host device), such as the host device 190. The controller 110 may include a hardware processor (not shown) that executes instructions stored at an internal memory, such as a read-only memory, to enable receipt and acknowledgment of eMMC instructions and data.

In another particular embodiment, the logic map and hardware engine 114 may include one or more media management units (e.g., media management automaters), a logical map, and one or more command application processors, as described with reference to FIGS. 2 and 3. The logic map and hardware engine 114 determines one or more physical addresses using a logical-to-physical address table. For example, upon a power-on event, the data storage device 102 may store the logical-to-physical address table from the non-volatile memory 130 to a random access memory (RAM) included in the controller 110. During operation of the data storage device 102, the data storage device 102 may change (e.g., update) entries of the logical-to-physical address table stored in the RAM. Prior to a power-down event, the data storage device 102 may write the logical-to-physical address table from the RAM to the non-volatile memory 130.

In another particular embodiment, the host device 190 may include an operating system, a file system table, a user interface, such as a graphical user interface (GUI), or a combination thereof. The host device 190 may communicate via an interface (not shown) that enables reading from the non-volatile memory 130 and writing to the non-volatile memory 130. For example, the host device 190 may operate in compliance with a Joint Electron Devices Engineering Council (JEDEC) industry specification, such as a Universal Flash Storage (UFS) Host Controller Interface specification. As other examples, the host device 190 may operate in compliance with one or more other specifications, such as a Secure Digital (SD) Host Controller specification as an illustrative example. The host device 190 may communicate with the non-volatile memory 130 in accordance with any other suitable communication protocol.

Because the command sequencer 112 assigns the tags 150-154 based on the first order, the controller 110 may execute the command 104, such as a series of commands or a long command having a plurality of sub-commands (e.g., access requests), in any order, such as in parallel (e.g., concurrently). The command 104 may be executed by the plurality of non-volatile memory devices 132 to generate output data and the data sequencer 120 may order the output data according to the first order based on the tags 150-154. By processing the command 104 (e.g., the series of commands or the plurality of sub-commands) in parallel, an amount of time to process and execute all of the commands (or sub-commands) may be shorter as compared to a data storage device that processes commands (or sub-commands) in a serial manner (e.g., one by one).

Referring to FIG. 2, a particular illustrative embodiment of a system 200 is depicted that includes a data storage module, such as the data storage device 102 of FIG. 1. Certain components and operations of the system 200 of FIG. 2 are described with reference to the system 100 of FIG. 1. The data storage device 102 may include a host interface 290, the controller 110, and the non-volatile memory 130. The host interface 290 may enable the data storage device 102 to be communicatively coupled to another device, such as the host device 190 of FIG. 1. The non-volatile memory 130 includes the non-volatile memory devices 132.

The controller 110 includes the command sequencer 112, multiple media management units 270-272, a logical map unit 274, multiple command application processors (CAPs) 280, 282, the sequence tag mapping data structure 116, the DMA modules 118, and the data sequencer 120. The multiple media management units 270-272, the logical map unit 274, the multiple CAPs 280, 282, or a combination thereof, may be included in the logic map and hardware engine 114 of FIG. 1.

The command sequencer 112 may receive a series of commands via the host interface 290. For example, the command sequencer 112 may receive one or more commands from a host device via the host interface 290. The series of commands may be received at the command sequencer 112 in a first order (e.g., a first sequential order). Each command may include a corresponding logical address and may be associated with an access request to be executed at the non-volatile memory 130.

The command sequencer 112 may generate multiple tags, such as a first tag 260, a second tag 262, and an Nth tag 264, based on the first order. The command sequencer 112 may attach a corresponding tag to each received command of the series of commands. For example, the command sequencer 112 may attach the first tag 260 to a first command, may attach the second tag 262 to a second command that is received subsequent to the first command, and may attach the Nth tag 264 to an Nth command that is received subsequent to the second command. Although three tags 260, 262, 264 are illustrated in the system 200, the command sequencer 112 may generate fewer than or more than three tags. The first command may be included in a group of the multiple groups 140-144 of FIG. 1 and the second command may be included in another group of the multiple groups 140-144 of FIG. 1.

After a particular tag is attached to a corresponding particular command, the particular command may be provided to one of the media management units 270-272. For example, the command sequencer 112 may identify a logical address of a particular command and provide the particular command to one of the media management units 270-272 based on the identified logical address. As another example, the command sequencer 112 may identify a logical address range associated with the particular command and provide the particular command to one of the media management units 270-272 based on the identified logical address range. The command sequencer 112 may send multiple commands to the media management units 270-272 in parallel (e.g., concurrently).

Each media management unit 270-272 may perform processing on the one or more received commands. For example, a particular media management unit may receive a particular command and process (e.g., using a pipeline) the particular command. The particular media management unit may include dedicated resources to process the particular command using media management unit level commands Processing the particular command may include decoding the particular command, identifying a logical address of the particular command, formatting one or more parameters associated with the particular command, or a combination thereof. The particular media management unit may output the processed command to the logical map unit 274. For example, the first media management unit 270 may receive, from the command sequencer 112, the first command having the first sequence tag 260 attached, process the first command, and output a processed first command having the first sequence tag 260 attached to the logical map unit 274. The second media management unit 271 may receive, from the command sequencer 112, the second command having the second sequence tag 262 attached, process the second command, and output a processed second command having the second sequence tag 262 attached to the logical map unit 274. The second media management unit 271 may receive, from the command sequencer 112, the Nth command having the Nth sequence tag 264 attached, process the Nth command, and output a processed Nth command having the Nth sequence tag 264 attached to the logical map unit 274. Although three media management units 270-272 are illustrated in the system 200, the system 200 may include fewer than or more than three media management units.

As an illustrative example, a first media management unit 270 may receive the first command associated with the first tag 260, a second media management unit 271 may receive the second command associated with the second tag 262, and a third media management unit 272 may receive the Nth command associated with the Nth tag 264. The first media management unit 270 may process the first command and provide the processed first command associated with the first tag 260 to the logical map unit 274. The second media management unit 271 may process the second command and provide the processed second command associated with the second tag 262 to the logical map unit 274. The third media management unit 272 may process the Nth command and provide the processed Nth command associated with the Nth tag 264 to the logical map unit 274. Processing of the first command, the second command, and the Nth command by the first media management unit 270, the second media management unit 271, and the third media management unit 272, respectively, may occur in parallel (e.g., concurrently, such as at least partially at the same time).

The logical map unit 274 may receive one or more commands from the media management units 270-272. Each of the one or more commands received from the media management units 270-272 may include a corresponding logical address. The logical map unit 274 may be configured to translate each particular logical address associated with one of the commands into a corresponding physical address. For example, the logical map unit 274 may perform a look-up table operation to translate each logical address to a corresponding physical address. The logical map unit 274 may map each physical address to a corresponding thread of one of the command application processors (CAPs) 280, 282, as described further herein.

As an illustrative example, the logical map unit 274 may be configured to map a first logical address of the first command to a first physical address. The logical map unit 274 may assign (e.g., map) the first command to a first thread based on the first physical address associated with the first command. The logical map unit 274 may be configured to map a second logical address of the second command to a second physical address and to assign (e.g., map) the second command to a second thread based on the second physical address. The logical map unit 274 may be configured to map a third logical address of the Nth command to a third physical address and to assign (e.g., map) the Nth command to a third thread based on the third physical address.

For each command mapped by the logical map unit 274, the logical map unit 274 may determine a corresponding sequence tag associated with the command and identify a thread to which the command is mapped. For example, when the logical map unit 274 maps a particular command to a particular thread, the logical map unit 274 may remove a sequence tag assigned to the particular thread and may identify the particular thread. The logical map unit 274 may store the sequence tag (e.g., a sequence tag value) based on the particular thread in the sequence tag mapping data structure 116. In a particular embodiment, the logical map unit 274 may store the sequence tag and an identifier of the particular thread as an entry in the sequence tag mapping data structure 116.

In a particular embodiment, the logical map unit 274 may be configured to translate one or more logical addresses associated with each group of the multiple groups 140-144 of FIG. 1 into a corresponding physical address. The logical map unit 274 may assign a particular group of the multiple groups 140-144 to a corresponding thread based on a physical address associated with the particular group. For example, the logical map unit 274 may assign the first group 140 of the multiple groups 140-144 to a first thread based on a first physical address associated with the first group 140. The logical map unit 274 may identify the first tag 150 associated with the first group 140 and identify a first identifier (e.g., a thread identifier) associated with the first thread. The logical map unit 274 may store the first tag 150 and the first identifier at the sequence tag mapping data structure 116. The logical map unit 274 may assign the second group 142 of the multiple groups 140-144 to a second thread based on a second physical address associated with the second group 142. The logical map unit 274 may store the second tag 152 associated with the second group 142 and may store a second identifier associated with the second thread at the sequence tag mapping data structure 116. The logical map unit 274 may assign the Nth group 144 of the multiple groups 140-144 to a third thread based on a third physical address associated with the Nths group 144. The logical map unit 274 may store the Nth tag 154 associated with the Nth group 144 and may store a third identifier associated with the third thread at the sequence tag mapping data structure 116.

The sequence tag mapping data structure 116 may include one or more sequence tags 226 and one or more thread identifiers 228. In a particular embodiment, the sequence tag mapping data structure 116 includes a table. A particular sequence tag identifier and a corresponding thread identifier may be stored as an entry in the table. The sequence tag mapping data structure 116 may be accessible to the logical map unit 274, the multiple DMA modules 118, or another device or component included in or coupled to the data storage device 102. The sequence tag mapping data structure 116 may be searchable, such as by the multiple DMA modules 118, as described further herein.

The CAPs 280, 282 may each include a corresponding plurality of threads. Each of the CAPs 280, 282 may generate an access request (e.g., an access command, such as a non-volatile memory device command) for each corresponding thread having an assigned command. The access request, such as a read access or a write access, may be configured to be executed by one of the non-volatile memory devices 132. The CAPs 280, 282 may issue each access request from a corresponding thread to a corresponding non-volatile memory device (e.g., a physical hardware device) of the plurality of non-volatile memory devices 132. Accordingly, the identifier of a particular thread may correspond to a particular non-volatile memory device. The CAPs 280, 282 may send the access requests to the non-volatile memory devices 132 serially (e.g., one at a time), in parallel (e.g., concurrently), or a combination thereof, and in any order.

The plurality of non-volatile memory devices 132 may receive multiple access requests from the CAPs 280, 282. The plurality of memory devices may execute the multiple access requests and output a plurality of output data items to the multiple DMA modules 118.

The multiple DMA modules 118 may receive the plurality of output data items from the plurality of non-volatile memory devices 132. Each DMA module may receive a corresponding output data item, buffer the output data item, and attach a sequence tag to the output data item. For example, a first DMA module may receive first output data item, based on the first access request, from a first non-volatile memory device. The first DMA module may identify a thread associated with (e.g., corresponding to) the first non-volatile memory device. The first DMA module may query (e.g., search) the sequence tag mapping data structure 116 to identify a particular sequence tag based on the identified thread. The first DMA module may retrieve the particular sequence tag and attach the particular sequence tag to the first output data item. The multiple DMA modules 118 may attach a sequence tag to each of the plurality of output data items received by the multiple DMA modules 118.

The data sequencer 120 may receive the plurality of output data items including the sequential tags. The data sequencer 120 may receive the plurality of output data items in a second order that is different from the first order. The data sequencer 120 may reorder the plurality of output data items according to the first order based on the sequence tags attached. The data sequencer 120 may send the reordered plurality of output data items in the first order to the host interface 290. In a particular embodiment, the data sequencer 120 provides the reordered plurality of output data items in the first order to a host device, such as the host device 190 of FIG. 1, via the host interface 290. The host interface 290 may include an embedded MultiMedia Card (eMMC) interface or a universal serial bus (USB) interface.

Referring to FIG. 3, a particular illustrative embodiment of a system 300 is depicted that includes a data storage module, such as the data storage device 102 of FIG. 1. Certain components and operations of the system 300 of FIG. 3 may be described with reference to the system 100 of FIG. 1 or the system 200 of FIG. 2. For example, the system 300 of FIG. 3 includes the controller 110 of FIGS. 1 and 2.

The command sequencer 112 of the controller 110 may receive a long command including a plurality of sub-commands. For example, the command sequencer 112 may receive the long command from a host device, such as the host device 190 of FIG. 1, via the host interface 290 of FIG. 2. The plurality of sub-commands may be included in the long command in a first order (e.g., a first sequential order). Each sub-command may include a corresponding logical address and may be associated with an access request to be executed at a non-volatile memory, such as the non-volatile memory 130 of FIGS. 1 and 2.

The command sequencer 112 may divide the long command into multiple groups that each include one or more sub-commands. For example, the multiple groups may include the multiple groups 140-144 of FIG. 1. Each sub-command may correspond to an access request (e.g., an access command) to be executed at a non-volatile memory, such as the non-volatile memory 130 of FIG. 1.

The command sequencer 112 may generate multiple tags, such as a first tag 310, a second tag 312, and an Nth tag 314, based on the first order. The command sequencer 112 may be configured to attach a corresponding tag to each group of one or more sub-commands to identify a position of each group of one or more sub-commands within the first order. For example, the command sequencer 112 may attach the first tag 310 to a first group, may attach the second tag 312 to a second group of sub-commands that are subsequent to sub-commands included in the first group, and may attach the Nth tag 314 to an Nth group that includes one or more sub-commands that are subsequent to sub-commands included in the second group. Although three tags 310, 312, 314 are illustrated in the system 300, the command sequencer 112 may generate fewer or more than three tags

After a particular tag is attached to a corresponding particular group, the particular group may be provided to one of the media management units 270-272. The command sequencer 112 may identify a particular logical address range associated with the particular group and provide the particular group to one of the media management units 270-272 based on the identified logical address range. The command sequencer 112 may send multiple groups to the media management units 270-272 in parallel (e.g., concurrently).

Each media management unit 270-272 may perform processing on the one or more received groups, as described with reference to FIG. 2. The media management units 270-272 may also divide each received group of sub-commands into a corresponding sub-group of commands (e.g., a sub-group of access requests). In a particular embodiment, the media management units 270-272 may divide each group of sub-commands into one or more individual sub-commands. The media management units 270-272 may generate multiple sub-tags and attach a corresponding sub-tag to each sub-command to identify a position (e.g., an order), based on the first order, of each sub-command within a corresponding group.

For example, a first media management unit 270 may receive the first group of sub-commands having the first tag 310 attached to the first group. The media management unit 270 may divide the first group of sub-commands into a first sub-command, a second sub-command, and an Nth sub-command. The media management unit 270 may attach a corresponding sub-tag (e.g., sub-identifier) to each of the sub-commands. Accordingly, each sub-command of the first group may be associated with a corresponding unique tag (e.g., a unique sequential tag) including a tag attached by the command sequencer 112 and a sub-tag attached by the media management unit 270. For example, the first sub-command may be associated with a first unique tag 350, the second sub-command may be associated with a second unique tag 352, and the Nth sub-command may be associated with an Nth unique tag 354. Accordingly, each unique tag 350-354 may include a first portion attached by the command sequencer 112. A value of the first portion attached by the command sequencer 112 may indicate a group sequential order of each group generated based on the long command. Each unique tag 350-354 may include a second portion attached by a media management unit 270-272. A value of the second portions attached by the media management units 270-272 may indicate a sub-command sequential order (e.g., an access request sequential order) that corresponds to the first order. The media management units 270-272 may provide, in parallel (e.g., concurrently), each of the sub-commands having a corresponding attached unique tag to the logical map unit 274.

The logical map unit 274 may receive the sub-commands and corresponding unique tags from the media management units 270-272. Each of the sub-commands received from the media management units 270-272 may include a corresponding logical address. The logical map unit 274 may be configured to translate each of the logical addresses associated with the sub-commands into a corresponding physical address. The logical map unit 274 may assign (e.g., map) each of the sub-commands to a corresponding thread of the CAPs 280, 282 based on the corresponding physical address of each command. For each sub-command mapped by the logical map unit 274, the logical map unit 274 may determine (e.g., identify) a corresponding unique tag associated with the sub-command and an identifier of a thread to which the sub-command is mapped. The logical map unit 274 may store the unique tag (e.g., a unique tag value associated with the sub-command) and the identifier of the particular thread in the sequence tag mapping data structure 116.

Each CAPs 280, 282 may generate an access request (e.g., an access command, such as a non-volatile memory device command) for each corresponding thread having an assigned sub-command. The CAPs 280, 282 may issue each access request from a corresponding thread to a corresponding non-volatile memory device (e.g., a physical hardware device), such as one of the plurality of non-volatile memory devices 132 of FIG. 1. The CAPs 280, 282 may send the access requests to the non-volatile memory devices 132 serially (e.g., one at a time), in parallel (e.g., concurrently), or a combination thereof, and in any order. Execution of the access requests by the plurality of non-volatile memory devices 132 and subsequent processing of output data by the controller 110 may proceed in a similar manner as described with reference to FIGS. 1 and 2. For example, the DMA modules 118 may receive a plurality of output data items from the plurality of non-volatile memory devices 132. The DMA modules 118 may identify and attach a corresponding unique tag to each data output item of the plurality of data output items. The DMA modules 118 may provide the plurality of output data items and corresponding attached unique tags to the data sequencer 120. The data sequencer 120 may order (e.g., re-order) the received plurality of output data items according to the first order based on the attached unique tags. For example, the data sequencer 120 may order the plurality of output data items into ordered groups based on a group tag portion of each unique tag and may order each group into ordered sub-commands based on a sub-tag portion of each unique tag. The data sequencer 120 may provide the reordered plurality of output data items in the first order to a host device, such as the host device 190 of FIG. 1, via the host interface 290. The host interface 290 may include an embedded MultiMedia Card (eMMC) interface or a universal serial bus (USB) interface.

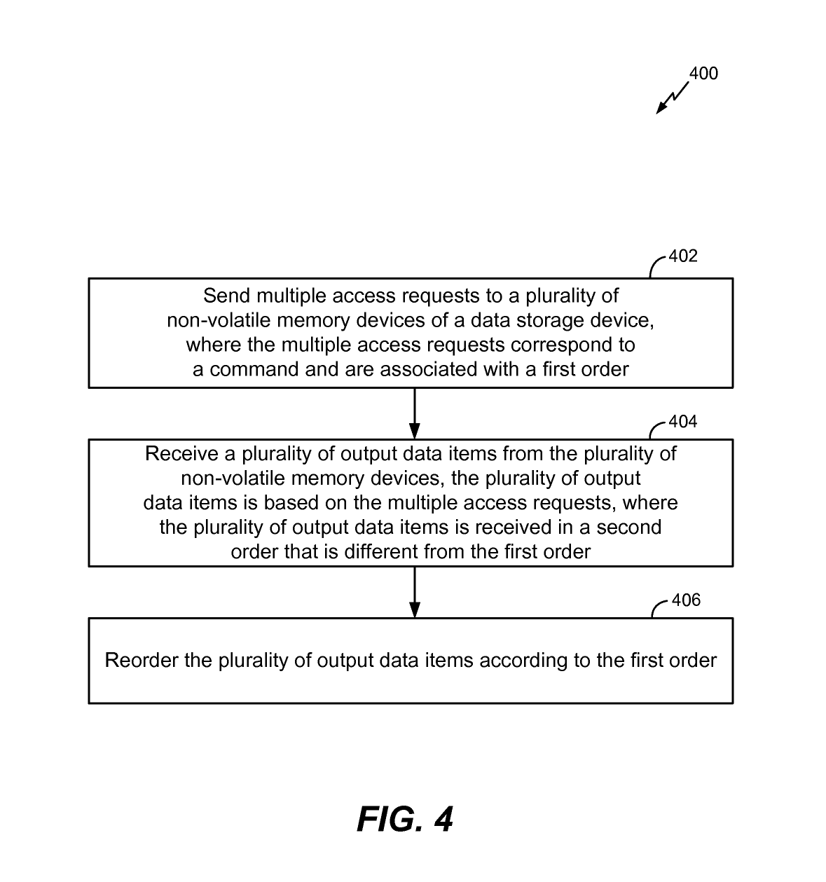

FIG. 4 illustrates a particular embodiment of a method 400 performed at the data storage device 102 of FIG. 1. For example, the method 400 may be performed by the controller 110 of FIGS. 1-3.

The method 400 includes sending multiple access requests to a plurality of non-volatile memory devices of a data storage device, at 402. The multiple access requests may correspond to a command and are associated with a first order. For example, the logic map and hardware engine 114 of FIG. 1 or the CAPs 280, 282 of FIGS. 2 and 3 may send multiple access requests to the plurality of non-volatile memory devices, such as the plurality of non-volatile memory devices 132 of FIG. 1.

The method 400 also includes receiving a plurality of output data items from the plurality of non-volatile memory devices, at 404. The plurality of output data items is based on the multiple access requests. The plurality of output data items is received in a second order that is different from the first order. For example, the output data items may be received by the DMA modules 118 of FIG. 1.

The plurality of output data items is reordered according to the first order, at 406. For example, the plurality of output data items may be reordered from the second order according to the first order by a data sequencer, such as the data sequencer 120 of FIG. 1. The first order may be an order in which a host device, such as the host device 190, issued one or more commands and expects to receive the plurality of output data items.

The method 400 of FIG. 4 may be initiated or controlled by a field-programmable gate array (FPGA) device, an application-specific integrated circuit (ASIC), a processing unit, such as a central processing unit (CPU), a digital signal processor (DSP), a controller, another hardware device, a firmware device, or any combination thereof. As an example, the method 400 of FIG. 4 can be initiated or controlled by one or more processors include in or coupled to the data storage device 102 of FIG. 1.

A controller configured to perform the method 400 of FIG. 4, may be able to advantageously dispatch the multiple access requests (e.g., commands associated with the first order) in parallel. The controller may dispatch the multiple access requests without regard for (e.g., independent of) the first order. The controller may receive the plurality of output data items responsive to the multiple access requests. The plurality of output data items may have the second order which is different than the first order. A device, such as the host device 190 may expect to receive the plurality of output data items according to the first order. Thus, the controller may reorder the plurality of output data items from the second order to the first order. By reordering the plurality of output data items in the first order, the controller (e.g., the data storage device) may be able to efficiently process the one or more commands in parallel rather than in a sequential manner.

Although various components depicted herein are illustrated as block components and described in general terms, such components may include one or more microprocessors, state machines, or other circuits configured to enable the data storage device 102 to perform the particular functions attributed to such components, or any combination thereof. For example, components described herein, such as the controller 110 of FIG. 1, may represent physical components, such as hardware controllers, state machines, logic circuits, or other structures to enable the data storage device 102 of FIGS. 1-3 to generate a plurality of tags based on a received order of one or more commands (or sub-commands) and output data generated based on the one or more commands (or sub-commands) from a beginning of a system to an end of the system and to provide the output data from the data storage device 102 according to the received order. When the data returns from each engine, the data is presented back based on the command tag to maintain the command order. In a particular embodiment, the data storage device 102 of FIGS. 1-3 includes instructions that are executed by a processor and the instructions are stored at the non-volatile memory 130. Alternatively, or in addition, instructions that are executed by a processor may be stored at a separate memory location that is not part of the non-volatile memory 130 such as at a read-only memory (ROM) (not shown). The instructions stored at the non-volatile memory 130 or the ROM may be transferable to a RAM included in the controller 110 for execution by the processor.

In a particular embodiment, the data storage device 102 may be a portable device configured to be selectively coupled to one or more external devices. For example, the data storage device 102 may be a removable device such as a Universal Serial Bus (USB) flash drive or a removable memory card, as illustrative examples. However, in other embodiments, the data storage device 102 may be attached to, or embedded within, one or more host devices, such as within a housing of a portable communication device. For example, the data storage device 102 may be within a packaged apparatus such as a wireless telephone, a personal digital assistant (PDA), a gaming device or console, a portable navigation device, a computer device, or other device that uses internal non-volatile memory. In a particular embodiment, the non-volatile memory 130 includes a flash memory (e.g., NAND, NOR, Multi-Level Cell (MLC), Divided bit-line NOR (DINOR), AND, high capacitive coupling ratio (HiCR), asymmetrical contactless transistor (ACT), or other flash memories), an erasable programmable read-only memory (EPROM), an electrically-erasable programmable read-only memory (EEPROM), a read-only memory (ROM), a one-time programmable memory (OTP), or any other type of memory.

The illustrations of the embodiments described herein are intended to provide a general understanding of the various embodiments. Other embodiments may be utilized and derived from the disclosure, such that structural and logical substitutions and changes may be made without departing from the scope of the disclosure. This disclosure is intended to cover any and all subsequent adaptations or variations of various embodiments. Accordingly, the disclosure and the figures are to be regarded as illustrative rather than restrictive.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description. Accordingly, the disclosure and the figures are to be regarded as illustrative rather than restrictive.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments.

The above-disclosed subject matter is to be considered illustrative, and not restrictive, and the appended claims are intended to cover all such modifications, enhancements, and other embodiments, which fall within the scope of the present disclosure. Thus, to the maximum extent allowed by law, the scope of the present invention is to be determined by the broadest permissible interpretation of the following claims and their equivalents, and shall not be restricted or limited by the foregoing detailed description.

What is claimed is:

1. A method comprising:
at a controller of a data storage device, performing:
sending multiple access requests to a plurality of non-volatile memory devices of the data storage device, wherein the multiple access requests correspond to a command and are associated with a first order;
receiving a plurality of output data items from the plurality of non-volatile memory devices, the plurality of output data items based on the multiple access requests, wherein the plurality of output data items is received in a second order that is different from the first order; and
reordering the plurality of output data items according to the first order.

2. The method of claim 1, wherein the command includes a request to access a non-volatile memory coupled to the controller, the non-volatile memory including the plurality of non-volatile memory devices.

3. The method of claim 1, wherein the plurality of non-volatile memory devices includes a plurality of NAND flash devices.

4. The method of claim 1, further comprising sending the reordered plurality of output data items to a host device.

5. The method of claim 1, further comprising:
attaching a first sequence tag associated with the first order to first output data of the plurality of output data; and
attaching a second sequence tag associated with the first order to second output data of the plurality of output data.

6. The method of claim 5, wherein reordering the plurality of output data comprises ordering the first output data and the second output data in the first order based on the first sequence tag and the second sequence tag.

7. The method of claim 5, further comprising:
identifying the first sequence tag from a plurality of stored sequence tags, wherein the first sequence tag is identified based on a first non-volatile memory device that generated the first output data; and
identifying the second sequence tag of the plurality of stored sequence tags, wherein the second sequence tag is identified based on a second non-volatile memory device that generated the second output data.

8. The method of claim 7, wherein the first sequence tag corresponds to a first access request of the multiple access requests, and wherein the first output data is generated by the first non-volatile memory device.

9. The method of claim 8, wherein the first output data is generated by the first non-volatile memory device based on the first access request.

10. The method of claim 1, further comprising:
receiving, at the data storage device, the command from a host device;
dividing the command into multiple groups; and
attaching a first sequence tag to each group of the multiple groups, wherein a value of the first sequence tag indicates a group sequential order of each group of the multiple groups, the group sequential order corresponding to the first order.

11. The method of claim 10, further comprising:
dividing a first group of the multiple groups into a first sub-group of access requests; and
attaching a second sequence tag to each access request of the first sub-group of access requests, wherein a value of the second sequence tag indicates an access request sequential order of each of the access requests of the first sub-group.

12. The method of claim 11, wherein a particular access request of the first sub-group of access requests includes a unique sequence tag, wherein the unique sequence tag comprising the first sequence tag and the second sequence tag is associated with the particular access request, and wherein a value of the unique sequence tag indicates a position of the particular access request within the first order.

13. The method of claim 1, further comprising:
mapping a first access request of the multiple access requests from a logical address corresponding to the first access request to a physical address corresponding to the first access request; and
providing the first access request to a first thread associated with a particular non-volatile memory device of the plurality of non-volatile memory devices, wherein the first access request is mapped to the first thread based on the corresponding physical address.

14. The method of claim 13, further comprising:
storing a sequence tag of the first access request and a thread identifier corresponding to the first thread;
receiving first output data of the plurality of output data from the particular non-volatile memory device, the first output data based on the first access request;
identifying the thread identifier associated with the particular non-volatile memory device;
identifying the sequence tag based on the thread identifier; and
attaching the sequence tag to the first output data.

15. A data storage device comprising:
a command sequencer configured to generate multiple groups, wherein the multiple groups are associated with a first order and correspond to a command received by the command sequencer;
a plurality of direct memory access modules configured to receive a plurality of output data items from a plurality of non-volatile memory devices, the plurality of output data items based on the multiple groups, wherein the plurality of outputs data items is received in a second order that is different than the first order; and
a data sequencer configured to reorder the plurality of output data items according to the first order.

16. The data storage device of claim 15, further comprising a controller, wherein the controller includes the command sequencer and the data sequencer.

17. The data storage device of claim 15, further comprising a host interface, wherein the command is received by the command sequencer from a host device via the host interface, and wherein the reordered plurality of output data items is provided to the host device.

18. The data storage device of claim 15, wherein the command sequencer is further configured to:
identify a logical address range of each group of the multiple groups; and
provide a particular group of the multiple groups to a particular media management unit of a plurality of media management units based on a particular logical address range of the particular group.

19. The data storage device of claim 15, wherein the command sequencer is configured to attach a first sequence tag to each group of the multiple groups, wherein a value of the first sequence tag indicates a group sequential order of each group of the multiple groups, the group sequential order corresponding to the first order.

20. The data storage device of claim 19, further comprising a plurality of media management units, wherein a particular media management unit of the plurality of media management units is configured to:
divide a particular group of the multiple groups into multiple access requests;
attach a second sequence tag to each of the multiple access requests based on the first order, wherein a value of the second sequence tag indicates an access request sequential order of each access request of the multiple access requests, the access request sequential order corresponding to the first order; and
provide each of the multiple access requests to a logical map unit.

21. The data storage device of claim 15, further comprising a logical map unit configured to:
translate one or more logical addresses associated with each group of the multiple groups into a physical address;
assign a first group of the multiple groups to a first thread; and
assign a second group of the multiple groups to a second thread.

22. The data storage device of claim 21, wherein the logical map unit is configured to:
identify a sequence tag associated with the first group;
identify a thread identifier associated with the first thread; and
store the sequence tag and the thread identifier in a sequence tag mapping data structure, wherein the sequence tag mapping data structure is accessible to the plurality of direct memory access modules.
